(19) United States
(12) Patent Application Publication
(10) Pub. No.: US 2003/0223604 A1
(43) Pub. Date: Dec. 4, 2003

(54) Audio output apparatus having a wireless communication function, and method of controlling sound-source switching in the apparatus

(75) Inventor: Hideyuki Nakagawa, Kunitachi-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/359,194

(22) Filed: Feb. 6, 2003

(30) Foreign Application Priority Data
May 28, 2002 (JP) 2002-153685

(51) Int. Cl. H04R 5/02

(52) U.S. Cl. 381/311; 381/309

(57) ABSTRACT

An audio output apparatus comprises a sound output unit configured to output sound that corresponds to the audio data transmitted from a first sound source device connected by radio to the audio output apparatus, a priority-level comparing unit configured to compare priority information transmitted from the first sound source device and representing a priority level assigned thereto, with priority information transmitted from a second sound source device and representing a priority level assigned thereto, when the second sound source devices is connected by radio to the audio output apparatus while the audio output apparatus is outputting sound corresponding to the audio data transmitted from the first sound source device, and a sound-source selecting unit configured to select one of the first and second sound source devices, as a source of sound to be output, in accordance with the result of comparison performed by the priority-level comparing unit.

### CROSS-REFERENCE TO RELATED APPLICATIONS

This application is based upon and claims the benefit of priority from the prior Japanese Patent Application No. 2002-153685, filed May 28, 2002, the entire contents of which are incorporated herein by reference.

### BACKGROUND OF THE INVENTION

1. Field of the Invention

The present invention relates to an audio output apparatus such as a wireless headphone and to a method of controlling sound-source switching in the audio output apparatus. More particularly, the invention relates to an audio output apparatus that can communicate by radio with various types of sound sources such as portable audio players and mobile phones, and to a method of controlling sound-source switching in the audio output apparatus.

2. Description of the Related Art

In recent years, various types of portable audio players, such as portable CD (Compact Disk) players and portable mini-disk players, have come into common use. The users can enjoy listening to music, wherever they are.

Usually, the user of a portable audio player wears a headphone to listen to the music the player is reproducing. While wearing the headphone, he or she may fail to hear guidance made at railway stations or in trains, and may not aware of call arriving at his or her mobile phone.

Jpn. Pat. Appln. KOKAI Publication No. 2001-197019 discloses a CD player. When the CD player receives a connection request from an external communications device, the sound source is switched from the music data being reproduced from the CD, to the audio data transmitted by radio from the external communications device.

Every time the CD player receives a connection request, the CD player stops reproducing the data from the CD. Hence, the sound source must be switched from the music data to be reproduced from the CD, to the data transmitted from the external communications device, no matter which kind of music data is being reproduced.

The CD player disclosed in the Publication is designed to achieve one-to-one communication with a specified external communications device. It is not configured to communicate with a plurality of external communications device functioning as sound sources that can transmit audio data in the form of radio signals.

It is expected that various types of electronic apparatuses (e.g., portable audio players, mobile telephones and the like) that can perform short-range wireless communication will be developed and used as sound sources in the near future, thanks to the short-range communication technology represented by Bluetooth™. In view of this, the CD player must generate sound not only from the music data recorded on the CD or the audio data transmitted from an external sound source device, but also from a plurality of external sound source devices.

### BRIEF SUMMARY OF THE INVENTION

Embodiments of the present invention may provide an audio output apparatus and a sound-source switching method that can automatically switch one sound source device to another.

According to an embodiment of the present invention, there is provided an audio output apparatus capable of performing a wireless communication with a sound source device that transmits audio data, comprising: a sound output unit configured to output sound that corresponds to the audio data transmitted from a first sound source device connected by radio to the audio output apparatus; a priority-level comparing unit configured to compare priority information transmitted from the first sound source device and representing a priority level assigned thereto, with priority information transmitted from a second sound source device and representing a priority level assigned thereto, when the second sound source devices is connected by radio to the audio output apparatus while the audio output apparatus is outputting sound corresponding to the audio data transmitted from the first sound source device; and a sound-source selecting unit configured to select one of the first and second sound source devices, as a source of sound to be output by the sound output unit, in accordance with the result of comparison performed by the priority-level comparing unit.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the relation between an audio output apparatus that is an embodiment of the invention and the sound source devices that are connected by radio to the audio output apparatus;

FIG. 2 is a block diagram illustrating the wireless audio communication function provided in each of the sound source devices shown in FIG. 1;

FIG. 3 is a block diagram illustrating a structure that the audio output apparatus of FIG. 1 may have;

FIG. 4 is a flowchart explaining a part of the procedure of switching one sound source to another in the audio output apparatus shown in FIG. 1;

FIG. 5 is a flowchart explaining the remaining part of the procedure of switching one sound source to another in the audio output apparatus shown in FIG. 1;

FIG. 6 is a diagram depicting a format for the priority information that is supplied from a sound source device shown in FIG. 1 to the audio output apparatus when the sound source device is connected by radio to the audio output apparatus;

FIG. 7 is a flowchart explaining a procedure that the audio output apparatus of FIG. 1 may perform to select a sound source device again; and

FIG. 8 is a diagram illustrating how the first and second sound source devices are switched from one to the other when the audio output apparatus performs the procedure depicted in FIG. 7.

### DETAILED DESCRIPTION OF THE INVENTION

Embodiments of this invention will be described, with reference to the accompanying drawings.

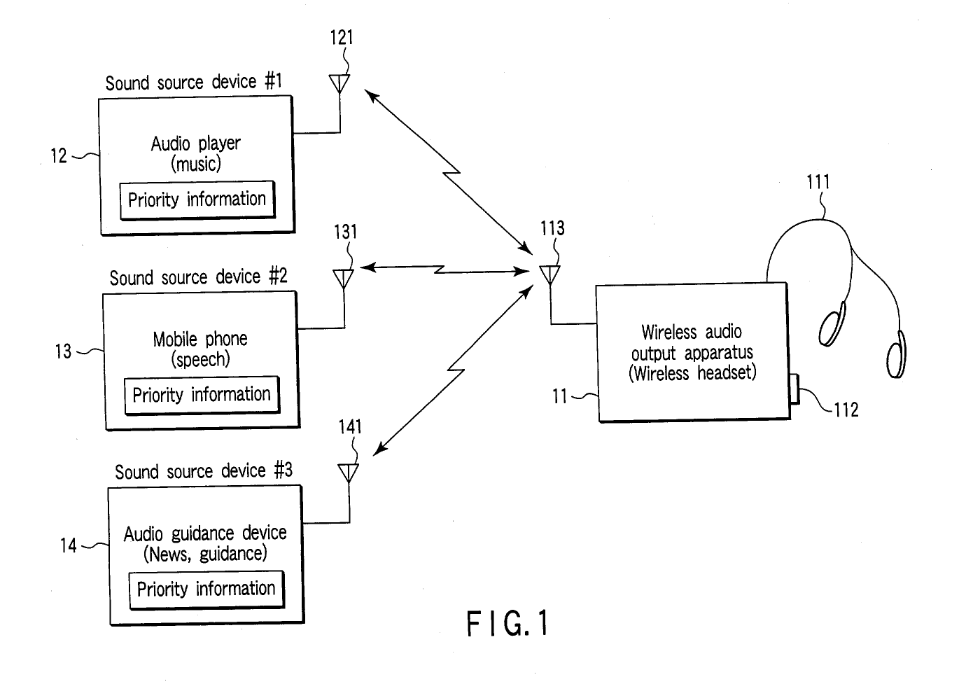

FIG. 1 shows the relation between an audio output apparatus that is an embodiment of the invention and the sound source devices that are connected by radio to the audio output apparatus. The audio output apparatus 11 is configured to receive audio data transmitted in the form of a radio signal from any sound source device and to generate sound from the audio data. The sound that the apparatus 11 generates is output via speaker or a headphone.

The audio output apparatus 11 is, for example, a wireless headset (comprising a speaker and a microphone). The user who wears the wireless headset can listen to the audio data transmitted, by a radio signal, from a sound source device and output through the headphone (or earphone) 111 that is provided as speaker in the wireless headset.

The wireless communication between the wireless audio output apparatus 11 and anyone of the sound source devices is implemented by a short-range communications system that accords with the Bluetooth™ standards. The wireless audio output apparatus 11 can therefore perform a wireless communication with various sound source devices having wireless communication function that are based on the Bluetooth™ standards.

Sound source devices are wireless audio transmitters that can transmit audio data representing speech, music and the like, in the form of radio signals. Assume that three sound source devices 12, 13 and 14 of difference types are available for the embodiment of the invention.

The sound source device (#1) 12 is a portable audio player such as a portable CD (Compact Disk) player or a portable mini-disk player. It has a short-range communication function that accords with the Bluetooth™ standards. This sound source device 12 has an antenna 121. The device 12 reads music data from a removable recording medium such as a CD or a mini-disk. The music data is transmitted by a radio signal, as audio data, from the antenna 121 to the wireless audio output apparatus 11. The user may put the sound source device (#1) 12 into a bag he or she has or into a pocket of the jacket he or she wears. Then, the user can listen to the music that the headphone 111 of the wireless audio output apparatus 11 is reproducing from the music data transmitted from the sound source device (#1) 12.

The sound source device (#2) 13 is a mobile phone. It has a wireless communication function based on the Bluetooth™ standards, in addition to the function of achieving wireless communication with the mobile phone network. This sound source device (#2) 13 has an antenna 131. The device 13 receives speech data from a base station incorporated in the mobile phone network and transmits the speech data, as audio data, from the antenna 131 to the wireless audio output apparatus 11. The user may put the sound source device (#2) 13 into a bag he or she has or into a pocket of the jacket he or she wears. Then, the user can hear the call-arrival tone and the speech of the calling person, which the headphone 111 of the apparatus 11 is reproducing from the audio data transmitted from the sound source device (#2) 13.

The wireless audio output apparatus 11 has a microphone 112. The user's speech input to the microphone 112 is transmitted by a radio signal from the antenna 113 to the sound source device (#2) 13. Thereby, the user can talk the calling person through the mobile phone network.

The sound source device (#3) 14 is, for example, an audio guidance device provided at railway stations or in trains. It has a wireless communication function that accords with the Bluetooth™ standards.

The sound source device (#3) 14 has an antenna 141. From the antenna 141, news, guidance or the like is transmitted, in the form of audio data, to the wireless audio output apparatus 11.

The wireless audio output apparatus 11 has the function of automatically switching any one of the sound source devices 12, 13 and 14 to another, as source of sound to be output by the apparatus 11. The automatic switching of sound source is performed in accordance with priority information. The information items representing the different priority levels that are assigned to the sound source devices 12, 13 and 14. The sound source device having the highest priority is selected as a source of sound to be output by the apparatus 11, prior to any other sound source devices.

When the sound source devices 12, 13 and 14 are connected by radio to the wireless audio output apparatus 11, they transmit the priority information items to the audio output apparatus 11, thus informing the apparatus 11 of the priority levels assigned to them. The wireless audio output apparatus 11 compares the priority levels of the sound source devices that are connected to it and selects the sound source device having the highest priority level. Thus, if a sound source device is connected by radio to the apparatus 11 and has a higher priority level than the sound source device now selected, the sound source for the apparatus 11 will be automatically switched to the sound source device newly connected to the apparatus 11. The user need not perform this switching of sound source. Conversely, if a sound source device having a lower priority level than the sound source device now selected is connected by radio to the apparatus 11, the sound source will not be switched at all. In this case, the user can keep listening to, for example, the music represented by the audio data transmitted from the sound source device selected at present.

The sound source device (#1) 12, which is a portable audio player, is triggered when the user operates it to reproduce, for example, music data. Thus triggered, the device 12 transmits a wireless-connection request to the audio output apparatus 11 and performs the procedure of establishing wireless connection (physical wireless link) between it and the audio output apparatus 11. When the wireless connection is established, the sound source device (#1) 12 transmits to the apparatus 11 the priority information item that represents the priority level assigned to it.

The priority level assigned to the sound source device (#1) 12 and represented by the priority information item stored in the device (#1) 12 is not fixed. The user can change the priority level to a desired value by operating, for example, the interface button switch provided on the sound source device (#1) 12.

The sound source device (#2) 13, which is a mobile phone, is triggered when it receives a call from, for example, the mobile telephone network. Thus triggered, the device 13 transmits a wireless-connection request to the audio output apparatus 11 and performs the procedure of establishing wireless connection (physical wireless link) between it and the audio output apparatus 11. When the wireless connection is established, the sound source device (#2) 13 transmits to the apparatus 11 the priority information item that represents the priority level assigned to it. The priority level assigned to the sound source device (#2) 13 and represented by the priority information item stored in the device (#2) 13 is not fixed, as in the case of the sound source device (#1) 12. The user can change the priority level to a desired value by operating, for example, the interface button switch provided on the sound source device (#2) 13.

The same person usually uses the wireless audio output apparatus 11 and the sound source devices 12 and 13. The user can therefore assign any priority levels he or she wants to the sound source devices 12 and 13.

Assume that the user has assigned a higher priority level to the sound source device 13 than to the sound source device 12. The sound source device 13 may be connected by radio to the wireless audio output apparatus 11 while the headphone 111 of the apparatus 11 is generating sound from the audio data transmitted from the sound source device 12. In this case, the sound source, from which the wireless audio output apparatus 11 (ultimately, the headphone 111) should reproduce audio data, is automatically switched from the sound source device 12 to the sound source device 13. Hence, when the sound source device 13 receives a call while the user is listening the music represented by the music data transmitted from the sound source device 12, the user can hear, without fail, the calling tone and the caller's speech.

The sound source device 12 should be disconnected from the wireless audio output apparatus 11 immediately after the sound source is switched from the sound source device 12 to the sound source device 13. Once the device 12 is so disconnected from the apparatus 11, it is possible to avoid the useless occupation of a wireless channel for transferring audio data that the headphone 11 will not output.

Usually, the sound source device 12, which is an audio player, keeps reading music data and reproducing the same from the recording medium, even after it is disconnected from the wireless audio output apparatus 11. In view of this it is desired that sound source device 12 be triggered to transmit a wireless-connection request every time it finishes reading one music data item from the recording medium (for example, from one track provided on the recording medium).

Thus, the sound source device 12 can transmits a wireless-connection request to the wireless audio output apparatus 11, every time it finishes reading one music data item, even after it is disconnected from the wireless audio output apparatus 11. The sound source device 12 is automatically selected again if the sound source device 13 is disconnected from the wireless audio output apparatus 11. The user can therefore enjoy listening again to the music represented by the music data transmitted from the sound source device 12 after he or she finishes talking with the caller, that is, after the sound source device 13 is disconnected from the wireless audio output apparatus 11. The user need not do anything to switch the sound source from the sound source device 13 to the sound source device 12.

The sound source device 13 can be disconnected from the wireless audio output apparatus 11 when the user pushes, for example, the on-hook button provided on the sound source device 13. When the on-hoof button is pushed, the sound source device 13 transmits a disconnection request to the wireless audio output apparatus 11. Upon receipt of this request, the apparatus 11 disconnects the device 13 from it.

The sound source device 14, which is an audio guidance device, can be disconnected from the wireless audio output apparatus 11 when it automatically transmits a disconnection request to the apparatus 11 after transmitting an audio message to the wireless audio output apparatus 11.

When the sound source device (#3) 14 needs to transmit an audio message, it transmits a wireless-connection request to the wireless audio output apparatus 11. In response to the wireless-connection request, the wireless audio output apparatus 11 connects the sound source device (#3) 14 to it. Thereafter, the sound source device (3#) 14 transmits a priority information item stored in it, to the wireless audio output apparatus 11. The priority information item represents the priority level assigned to the device (3#) 14. The priority level is not fixed. The person responsible for the sound source device (3#) 14 (i.e., an audio guidance device) may push a button switch provided on the device 14 to assign any desired priority level to the device (#3) 14. The sound source device (#3) 14 may be a sound source of emergency messages, such as evacuation orders. If so, the highest priority level should be assigned to the sound source device (#3) 14 and remain unchanged in the device (#3) 14. In this case, the sound source for the wireless audio output apparatus 11 is automatically switched from the sound source device 12 or 13 to the sound source device 14 when the device 14 is connected by radio to the apparatus 11 while the headphone 111 is generating sound from the audio data transmitted from the sound source device 12 or 13. Thus, the headphone 111 reliably generates emergency messages, which the user of the apparatus 11 can hear well.

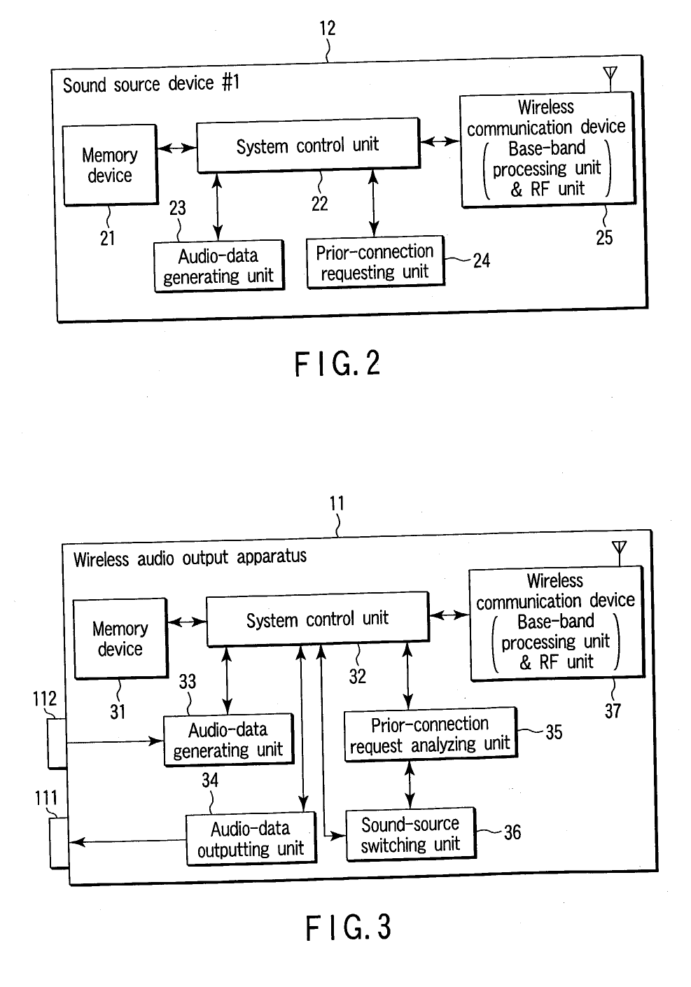

The sound source devices 12, 13 and 14 perform the same wireless audio communication function and are, therefore, identical in structure. Therefore, only the device 12 will be described, with reference to FIG. 2.

As FIG. 2 shows, the sound source device 12 comprises a memory device 21, a system control unit 22, an audio-data generating unit 23, a prior-connection requesting unit 24, and a wireless communications device 25.

The memory device 21 is a nonvolatile memory device. It stores programs and various items of data. The programs are used to control an operation of the sound source device 12. The memory device 21 stores priority information, too. The information represents the priority level assigned to the sound source device 12.

The system control unit 22 is a processor that controls some of the other components of the sound source device 12. It executes the programs stored in the memory device 21 to control the audio-data generating unit 23, prior-connection requesting unit 24, and wireless communications device 25. The audio-data generating unit 23 generates audio data that should be transmitted by radio from the sound source device 12. In the sound source device 12, the audio-data generating unit 23 reads and reproduces music data from the recording medium, thus generating the audio data to be transmitted.

The prior-connection requesting unit 24 generates a priority-level notifying command that contains the priority information item stored in the memory device 21. The command is transmitted via the wireless communications device 25 to the wireless audio output apparatus 11 after the sound source device 12 is connected by radio to the wireless audio output apparatus 11.

The wireless communications device 25 is designed to perform wireless communication with the wireless audio output apparatus 11. The device 25 comprises a base-band processing unit and a RF (Radio Frequency) unit. In response to an instruction from the system control unit 22, the device 25 transmits a wireless connection request to the wireless audio output apparatus 11 so that the sound source device 12 may be connected by radio to the wireless audio output apparatus 11. The wireless communication between the apparatus 11 and the device 25 is carried out in accordance with the Bluetooth™ standards.

The wireless audio output apparatus 11 may have the structure illustrated in FIG. 3.

As FIG. 3 shows, the wireless audio output apparatus 11 comprises a memory device 31, a system control unit 32, an audio-data generating unit 33, an audio-data outputting unit 34, a prior-connection request analyzing unit 35, a sound-source switching unit 36, and a wireless communication device 37.

The memory device 31 is, for example, a nonvolatile memory. The device 31 stores programs and various data items. The programs are used to control an operation of the wireless audio output apparatus 11. The system control unit 32 is a processor that controls some of the other components of the wireless audio output apparatus 11. The unit 32 executes the programs stored in the memory device 31 to control the audio-data generating unit 33, audio-data outputting unit 34, prior-connection request analyzing unit 35, sound-source switching unit 36 and wireless communication device 37.

The audio-data generating unit 33 receives a voice signal that the microphone 112 has generated from the user's voice and converts the voice signal to audio data. The audio-data outputting unit 34 and the headphone 111 are devices that output sound corresponding to audio data transmitted from the selected sound source device.

The audio-data outputting unit 34 is configured to receive the audio data through the system control unit 32 and supplies the same to the headphone 111. The headphone 111 generates sounds from the audio data it has received. The audio-data outputting unit 34 reproduces data to accomplish so-called “streaming playback.” That is, it receives an audio data stream from the sound source device selected at present, via the wireless communication device 37 and the system control unit 32, and then converts the audio data stream to an electric signal that the headphone 111 can convert into sound. Thus, the audio-data outputting unit 34 converts the audio data, which is a digital signal, to an analog signal. The analog signal is output to the headphone 111.

The prior-connection request analyzing unit 35 and the sound-source switching unit 36 are devices that accomplish the above-mentioned sound-source switching. The prior-connection request analyzing unit 35 analyzes the prior-connection request transmitted from the sound source device newly connected to the apparatus 11 and the prior-connection request transmitted from the sound source device selected and connected to the apparatus 11 at present. That is, every time a sound source device is connected to the apparatus 11, the unit 35 compares the prior-connection data contained in the prior-connection request transmitted from this sound source device, with the prior-connection data of the sound source device from which audio data is now being acquired.

The sound-source switching unit 36 is a device that selects a sound source device from which the apparatus 11 should acquire audio data, in accordance with the result of the comparison performed by the prior-connection request analyzing unit 35. The sound source device thus selected remains connected by radio to the wireless audio output apparatus 11, whereas the sound source device not selected is disconnected from the wireless audio output apparatus 11.

The wireless communication device 37 comprises a base-band processing unit and a RF unit. It operates to establish wireless connection between the apparatus 11 and the sound source device that has transmitted a wireless-connection request, to accomplish wireless communication between the apparatus 11 and that sound source device. The wireless communication is performed in accords with the Bluetooth™ standards. While performing the wireless communication, the wireless communication device 37 can receive wireless-connection requests from any other sound source devices. Hence, whichever sound source device is connected at any time to the wireless audio output apparatus 11, the wireless audio output apparatus 11 can select the sound source device that has a higher priority level than any other sound source device connected to the apparatus 11 at that time.

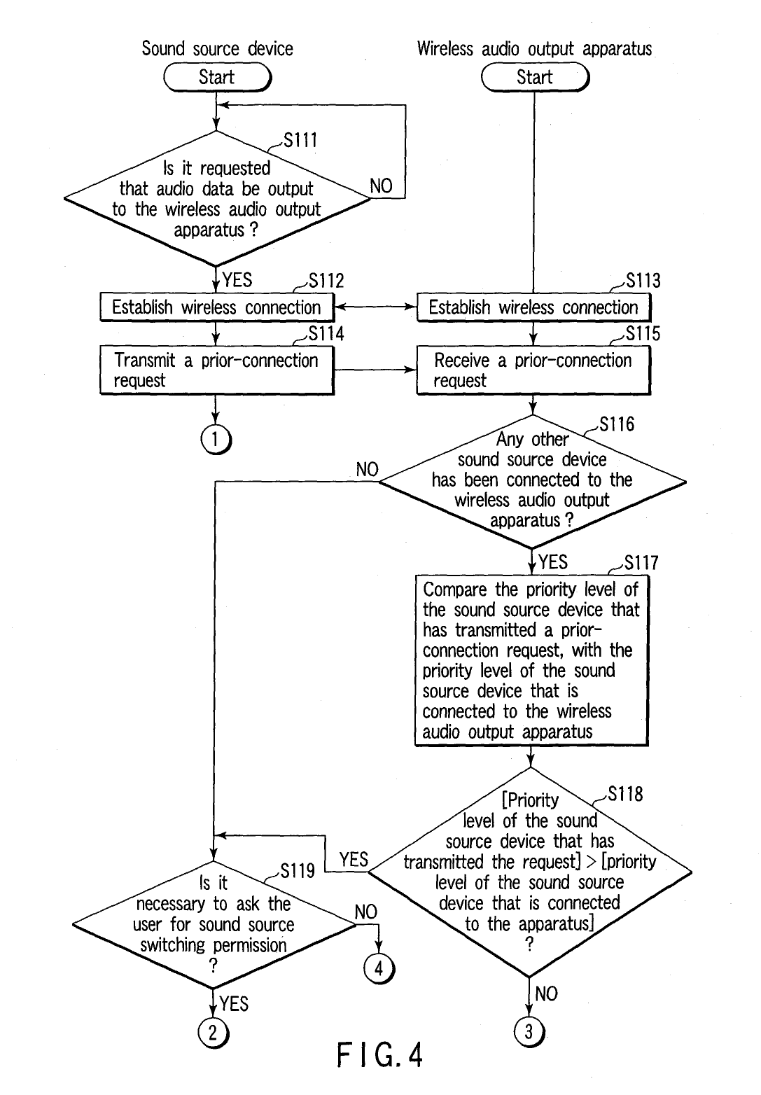

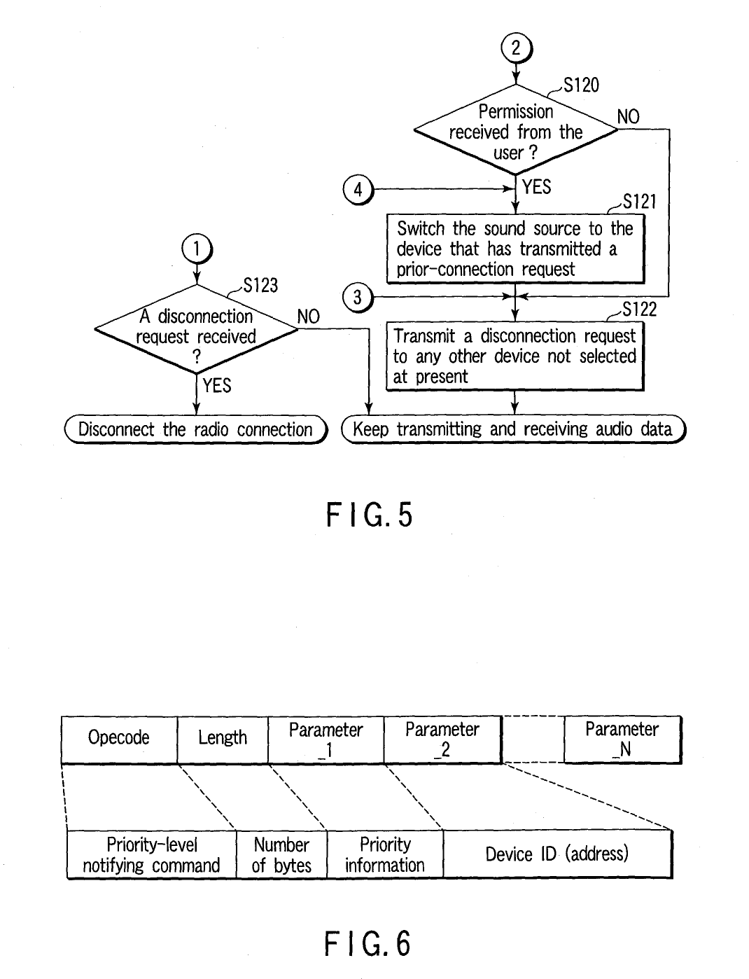

How the wireless audio output apparatus 11 switches the sound source will be explained, with reference to the flowchart of FIGS. 4 and 5.

Any one of the sound source devices 12, 13 and 14 may receive a request for transmitting audio data (YES at Step S111 shown in FIG. 4). The sound source device transmits a wireless-connection request to the wireless audio output apparatus 11 and starts a procedure to establish wireless connection between it and the wireless audio output apparatus 11 (Step S112). Also, the apparatus 11 starts a procedure to establish the wireless connection (Step S113). At Steps S112, S113, a physical wireless link is established between the wireless communication device 37 of the apparatus 11 and the wireless communications device 25 of the sound source device that has transmitted the wireless-connection request.

The sound source device (#1) 12 is triggered when the user instructs that audio data be reproduced. Thus triggered, the device (#1) 12 transmits a wireless-connection request to the wireless audio output apparatus 11. The sound source device (#2) 13 is triggered when it receives a call from, for example, the mobile phone network. Thus triggered, the device (#2) 13 transmits a wireless-connection request to the wireless audio output apparatus 11.

In any sound source device that is connected by radio to the wireless audio output apparatus 11, the prior-connection requesting unit 24 generates a priority-level notifying command. This command is transmitted by radio to the wireless audio output apparatus 11 (Step S114). The priority-level notifying command is a packet that has such a format as is shown in FIG. 6.

The packet is composed of an operation-code field (Opecode), a length-data field (Length) and at least two parameter fields (Parameter). The operation-code field indicates that the packet is a priority-level notifying command. The length-data field indicates the total length of the parameter fields that follow it. The first parameter field (Parameter_{—}1) indicates the priority level of the sound source device that has transmitted the packet. The second parameter field (Parameter_{—}2) indicates the device ID (address) of the sound source device that has transmitted the packet.

The wireless audio output apparatus 11 receives a prior-connection request from a sound source device (Step S115). The apparatus 11 then determines whether any other sound source device has been connected by radio to it, or selected as sound source from which the apparatus 11 may acquire audio data (Step S116). If YES at Step S116, the prior-connection request analyzing unit 35 compares the priority level of the sound source device that has transmitted the prior-connection request, with the priority-level of the other sound source device that has been connected by radio to the wireless audio output apparatus 11 (Step S117).

It is determined whether the priority level of the sound source device that has transmitted the prior-connection request is higher than the priority-level of the other sound source device that has been connected to the apparatus 11 (Step S118). If YES at Step S118, the system control unit 32 issues a permission-request for inquiring the user of the apparatus 11 whether the source of the sound to be output should be switched, asking the user for sound-source switching permission (Steps S119, S120).

To inquiry the user whether the source of the sound to be output should be switched, it is desirable to cause the headphone 111 of the apparatus 11 to generate a melody, a beep, a voice message or the like, which informs the user that another sound source having a higher priority level than the sound source from which audio data is being reproduced has been connected by radio to the wireless audio output apparatus 11. In response to this inquiry, the user may push a specific button provided on the apparatus 11 to give permission. It is easier for the user to input an oral permission to the microphone 112. In this case, the system control unit 32 recognizes the oral permission. To reject the request for sound-source switching, the user may push a button provided on the apparatus 11 or may do nothing at all. In the latter case, the system control unit 32 recognizes that the permission-request for sound-source switching is rejected, upon lapse of a predetermined time from the issue of that permission-request.

It is then determined whether the sound-source switching is allowed by the user (Step S120). If YES at Step S120, the prior-connection request analyzing unit 35 transmits a sound-source switching request to the sound-source switching unit 36. This request indicates that the sound source device that has transmitted the prior-connection request, i.e., the device most recently connected by radio to the apparatus 11, should be selected. Upon receipt of the sound-source switching request, the sound-source switching unit 36 switches the sound source, from which audio data should be reproduced, from the sound source device that has been selected to the sound source device that has transmitted the prior-connection request (i.e., the device most recently connected by radio to the apparatus 11) (Step S121).

To disconnect the sound source device not selected from the apparatus 11, the wireless communication device 37 transmits a disconnection request to the sound source device (Step S122). The sound source devices connected by radio to the wireless audio output apparatus 11 determine whether they have received a disconnection request from the apparatus 11 (Step S123). Any sound source device disconnects itself from the wireless audio output apparatus 11 if it has received a disconnection request, and transmits audio data to the apparatus 11 if it has not received a disconnection request.

At Step S116, it may be determined that no other sound source device has been connected by radio to the apparatus 11. In this case, the priority levels of the sound source devices are not compared. Thus, the sound source device that has transmitted the prior-connection request is selected.

In Step S118, the priority level of the sound source device that has transmitted the prior-connection request may be determined to be equal to or lower than the priority-level of the other sound source device that has been connected to the apparatus 11. If this is the case, the other sound source device remains selected. Then, a disconnection request is transmitted to the sound source device that has transmitted a prior-connection request (Step S122). The sound source device that has transmitted a prior-connection request is therefore disconnected from the wireless audio output apparatus 11.

If it is determined at Step S119 that the permission-request need not be made to the user, the process at Step S120 is skipped. Hence, the sound source is automatically switched in accordance with the priority levels of the sound source devices. It is desirable for the user to operate the apparatus 11 so that the apparatus 11 may issue the permission-request. For example, the user may push a button provided on the apparatus 11, enabling the apparatus 11 to issue the permission-request. If the user rejects the permission-request, the apparatus 11 transmits a disconnection request to the sound source device that has transmitted the prior-connection request (Step S122). In this case, this sound source device is disconnected from the wireless audio output apparatus 11.

The sound source device that has been disconnected from the wireless audio output apparatus 11 transmits a wireless-connection request again when it is necessary for it to transmit audio data to the apparatus 11. When the sound source device is connected by radio to the apparatus 11, it transmits a prior-connection request containing the priority information. If any other sound source device having a priority level higher than the sound source device that has transmitted the prior-connection request is not connected by radio to the apparatus 11 at this time, the sound source device that has transmitted the prior-connection request, i.e., the device that has once been disconnected, will be selected. This takes places in the following conditions.

Assume that the sound source device 13 or 14 that has a priority level than the sound source device 12 is connected to the wireless audio output apparatus 11 while the headphone 111 is reproducing the audio data transmitted by radio from the sound source device 12. Then, the sound source is switched, from the sound source device 12 to the sound source device 13 or 14.

The sound source device 12 is therefore disconnected from the wireless audio output apparatus 11. Nonetheless, the music data is continuously reproduced in the sound source device 12 as has been described above. When the music data is completely reproduced and other music data is about to be reproduced, the sound source device 12 transmits a connection request to the wireless audio output apparatus 11. When the sound source device 12 is connected by radio to the apparatus 11, it transmits the information representing its priority level to the apparatus 11. If the sound source devices 13 and 14 have been disconnected from the apparatus 11, the sound source device 12 will be selected again. Hence, the wireless audio output apparatus 11 outputs the sound represented by the music data transmitted from the sound source device 12.

Any sound source device that is not selected is disconnected from the wireless audio output apparatus 11, because useless wireless communication between the apparatus 11 and any sound source device which need not reproduce audio data must be avoided. The sound source device can be selected, without disconnecting any sound source device not selected from the wireless audio output apparatus 11. In this case, a disconnection request is not transmitted to the sound source devices not selected (at Step S112), or only the audio data that the wireless communication device 37 has received from the sound source device selected is transmitted to the audio-data outputting unit 34. The audio data received from any sound source device not selected is discarded.

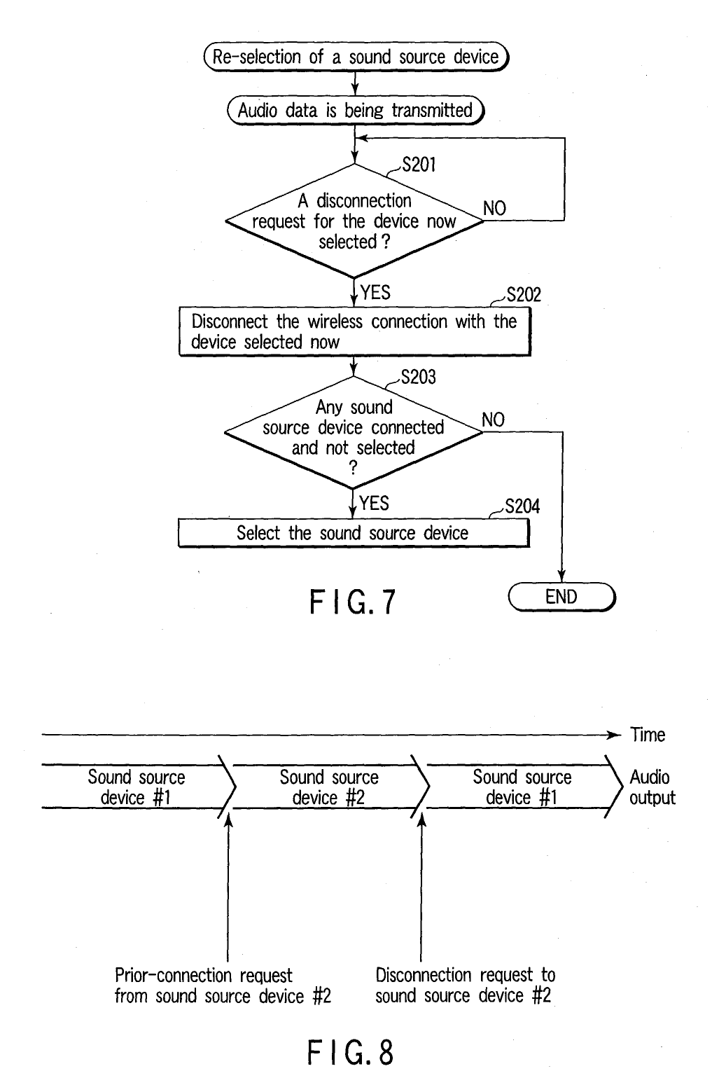

It will be described how any sound source device that has not been selected in the sound-source switching is selected, with reference to the flowchart of FIG. 7. Assume that any sound source device not selected remains connected by radio to the wireless audio output apparatus 11.

In the sound-source switching, the process (Step S122) of transmitting a disconnection request to any sound source device not selected is skipped. The sound-source switching is performed in the same procedure as explained with reference to FIGS. 4 and 5, except that Step S122 is skipped.

The wireless audio output apparatus 11 performs wireless communication with the sound source device selected at present, in order to receive audio data from the selected sound source device. The selected sound source device may generate a disconnection request in this condition, to be disconnected from the wireless audio output apparatus 11 (if YES at Step S201). If this is the case, the wireless audio output apparatus 11 disconnects the wireless link with the selected sound source device (Step S202).

Then, the wireless audio output apparatus 11 determines whether any audio device has been connected by radio to it and is not selected (Step S203). If YES, the apparatus 11 selects another sound source device as one from which to reproduce audio data (Step S204). The sound source device thus selected transmits audio data to the apparatus 11. The headphone 111 of the apparatus 11 generates sound from the audio data.

FIG. 8 illustrates how the first and second sound source devices 12 and 13 are switched from one to the other to be used as sound source from which to reproduce audio data.

The sound source device 13 that has a higher priority level than the sound source device 12 may be connected by radio to the wireless audio output apparatus 11 while the device 12 is reproducing audio data to be transmitted to the apparatus 11. If this is the case, the sound source is switched, from the device 12 to the device 13. The apparatus 11 therefore stops outputting the sound that corresponds to the audio data transmitted from the device 12, and starts outputting the sound that corresponds to the audio data transmitted from the device 13.

Thereafter, the user may operate the on-hook button provided on the device 13, transmitting a disconnection request to the apparatus 11. If this happens, the sound source device 13 is disconnected from the apparatus 11. Then, the sound source device 12 is selected again as one from which audio data should be transmitted to the wireless audio output apparatus 11. As a result, the apparatus 11 starts outputting the sound represented by the audio data transmitted from the sound source device 12.

In the wireless audio output apparatus 11 that is an embodiment of this invention, the priority information items transmitted from the sound source devices are used to automatically switch the sound source, from one sound source device to another. This automatic sound-source switching prevents the user from failing to listen to audio data that is important to him or her. Achieved by the use of the priority information transmitted to the apparatus 11, the automatic sound-source switching can be implemented by merely adding priority-level comparing hardware or firmware to the wireless audio output apparatus 11.

The wireless audio output apparatus 11, which can automatically switch the sound source, is fit for use as audio output devices, such as wireless headphones, which should be small, light and inexpensive.

Most sound source devices such as audio players, mobile phones and the like have an input device such as a ten-key pad, which functions as user interface. The user can easily set a priority level to the sound source device, by only operating the ten-key pad.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An audio output apparatus capable of performing a wireless communication with a sound source device that transmits audio data, comprising:
a sound output unit configured to output sound that corresponds to the audio data transmitted from a first sound source device connected by radio to the audio output apparatus;
a priority-level comparing unit configured to compare priority information transmitted from the first sound source device and representing a priority level assigned thereto, with priority information transmitted from a second sound source device and representing a priority level assigned thereto, when the second sound source devices is connected by radio to the audio output apparatus while the audio output apparatus is outputting sound corresponding to the audio data transmitted from the first sound source device; and
a sound-source selecting unit configured to select one of the first and second sound source devices, as a source of sound to be output by the sound output unit, in accordance with the result of comparison performed by the priority-level comparing unit.

2. The audio output apparatus according to claim 1, wherein the first and second sound source devices are configured to change the priority levels assigned to them.

3. The audio output apparatus according to claim 1, further comprising:
a microphone which receive a speech that a user produces; and
means for transmitting the speech received by the microphone to one of the first and second source devices, which is selected at present by the sound-source selecting unit.

4. The audio output apparatus according to claim 1, wherein the sound-source selecting unit includes means for maintaining wireless connection with one of the first and second sound source devices which has been selected and for disconnecting wireless connection with the other of the first and second sound source devices which has not been selected.

5. The audio output apparatus according to claim 1, wherein the sound-source selecting unit is configured to select the second sound source device if the priority information of the second sound source device represents a higher priority level than the priority information of the first sound source device, and to switch the source of the sound to be output by the sound output unit, from the first sound source device to the second sound source device.

6. The audio output apparatus according to claim 5, wherein the sound-source selecting unit includes:
means for inquiring the user whether the source of the sound to be output by the sound output unit should be switched from the first sound source device to the second sound source device if the priority information of the second sound source device represents a higher priority level than the priority information of the first sound source device; and
means for allowing or prohibiting switching the source of sound from the first sound source device to the second sound source device, in accordance with the user's response to the inquiry.

7. The audio output apparatus according to claim 1, wherein the sound-source selecting unit includes:
means for selecting the second sound source device and switching the source of the sound to be output by the sound output unit, from the first sound source device to the second sound source device, if the priority information of the second sound source device represents a higher priority level than the priority information of the first sound source device; and
means for selecting the first sound source device as the source of the sound to be output from the sound output unit, when the wireless connection with the second sound source device is disconnected after the source of the sound to be output by the sound output unit is switched from the first sound source device to the second sound source device.

8. An audio output apparatus to be wirelessly connected to at least first and second sound source devices, each configured to transmit priority information, in the form of a radio signal, to the audio output apparatus, said priority information representing the priority level assigned to the sound source device, said apparatus comprising:
means for receiving audio data transmitted in the form of a radio signal from the first sound source device connected by radio to the audio output apparatus at present and for causing a speaker or a headphone to generate sound from the audio data received;
means for comparing the priority information of the first sound source device with the priority information of the second sound source device, upon receipt of the priority information from the second sound source device newly connected by radio to the audio output apparatus while sound corresponding to the audio data transmitted from the first sound source device is being output; and
means for switching the source of sound to be output, from the first sound source device to the second sound source device, if the priority information of the second sound source device represents a higher priority level than the priority information of the first sound source device.

9. The audio output apparatus according to claim 8, further comprising means for disconnecting wireless connection with the first sound source device if the priority information of the second sound source device represents a higher priority level than the priority information of the first sound source device.

10. The audio output apparatus according to claim 8, further comprising:
means for inquiring the user whether the source of the sound to be output should be switched from the first sound source device to the second sound source device if the priority information of the second sound source device represents a higher priority level than the priority information of the first sound source device; and
means for allowing or prohibiting switching the source of the sound from the first sound source device to the second sound source device, in accordance with the user's response to the inquiry.

11. The audio output apparatus according to claim 8, further comprising means for selecting the first sound source device again as the source of the sound to be output, when the wireless connection with the second sound source device is disconnected.

12. A method of controlling an audio output apparatus capable of performing a wireless communication with a sound source device that transmits audio data, said method comprising:
outputting sound that corresponds to the audio data transmitted from a first sound source device connected by radio to the audio output apparatus;
comparing priority information transmitted from the first sound source device and representing a priority level assigned thereto, with priority information transmitted from a second sound source device and representing a priority level assigned thereto, when the second sound source devices is connected by radio to the audio output apparatus while the sound that corresponds to the audio data transmitted from the first sound source device is output; and
selecting one of the first and second sound source devices, as a source of sound to be output, in accordance with the result of comparison.

13. The method according to claim 12, wherein the selecting one of the first and second sound source devices includes:
maintaining wireless connection with one of the first and second sound source devices which has been selected as the source of the sound; and
disconnecting wireless connection with the other of the first and second sound source devices, which has not been selected.

14. The method according to claim 12, wherein the selecting one of the first and second sound source devices includes:
selecting the second sound source device if the priority information of the second sound source device represents a higher priority level than the priority information of the first sound source device; and
switching the source of the sound to be output, from the first sound source device to the second sound source device.

15. A method according to claim 14, wherein the selecting one of the first and second sound source devices further includes:
inquiring the user whether the source of the sound to be output should be switched from the first sound source device to the second sound source device if the priority information of the second sound source device represents a higher priority level than the priority information of the first sound source device; and
allowing or prohibiting switching the source of the sound from the first sound source device to the second sound source device, in accordance with the user's response to the inquiry.

16. The method according to claim 12, wherein the selecting one of the first and second sound source devices includes:
selecting the second sound source device and switching the source of the sound to be output, from the first sound source device to the second sound source device, if the priority information of the second sound source device represents a higher priority level than the priority information of the first sound source device; and
selecting the first sound source device as the source of the sound to be output, when the wireless connection with the second sound source device is disconnected after the source of the sound to be output is switched from the first sound source device to the second sound source device.
